(19) United States
(12) Patent Application Publication
(10) Pub. No.: US 2010/0145693 A1
(43) Pub. Date: Jun. 10, 2010

(54) METHOD OF DECODING NONVERBAL CUES IN CROSS-CULTURAL INTERACTIONS AND LANGUAGE IMPAIRMENT

(76) Inventor: Martin L Lenhardt, Hayes, VA (US)

Correspondence Address: Hershkovitz & Associates, LLC, 2845 Duke Street, Alexandria, VA, 22314, US

(21) Appl. No.: 12/600,609

(22) PCT Filed: Mar. 20, 2008
(86) PCT No.: PCT/US08/57668

§ 371 Date: Feb. 22, 2010

Related U.S. Application Data
(60) Provisional application No. 60/918,748, filed on Mar. 20, 2007.

(51) Int. Cl. G10L 15/00

(52) U.S. Cl. 704/231; 704/E15.001

(57) ABSTRACT

A method for extracting verbal cues is presented which enhances a speech signal to increase the saliency and recognition of verbal cues including emotive verbal cues. In a further embodiment of the method, the method works in conjunction with a computer that displays a face which gestures and articulates non-verbal cues in accord with speech patterns that are also modified to enhance their verbal cues. The methods work to provide a means for allowing non-fluent speakers to better understand and learn foreign languages.

### CROSS-REFERENCE TO RELATED APPLICATIONS

This application claims the benefit of provisional patent application No. 60/918,748 filed Mar. 20, 2007, the entirety of which is incorporated by reference.

### BACKGROUND OF THE INVENTION

1. Field of Invention

The present invention relates to a method of processing speech that allows a listener to better understand non-verbal cues.

2. Background of the Invention

Fluent speakers and listeners of a language can readily process the emotional, syntactical, grammatical, semantic, and contextual components of language. Non-fluent listeners focus heavily on one aspect of the speech process such as the literal, de-contextualized meaning of a phrase, at the expense of the emotional non-verbal cues, which often are used for proper decoding of the meaning. As such, there is a present need for a device, particularly a method which can be incorporated into a device, which can extract the emotive components of speech. In addition, a method that can utilize the extracted emotive component in connection with a means for presenting visual emotional cues would enhance the ability of a non-fluent speaker to become adept at recognizing crucial contextual content.

It is an object of the present invention to provide a method that accomplishes one or more of the above desired objectives. In addition, additional objects will become apparent after consideration of the following descriptions and claims.

### SUMMARY OF THE INVENTION

The present invention is, in one or more embodiments, a method for extracting emotive and/or prosodic verbal cues from speech for presentation to a listener comprising the steps of receiving a raw signal comprising speech using an input device; amplifying said raw signal using a first amplifier to produce an amplified signal; sending said amplified signal through a first and a second channel; filtering the amplified signal sent through said first channel with a low-frequency filter to produce a first filtered signal, then frequency multiplying the first filtered signal sent through said first channel to produce a frequency multiplied signal, then amplifying the frequency multiplied signal sent through said first channel with a second amplifier to produce a final first channel signal, and then sending the final first channel signal to the left ear of said listener; and filtering the amplified signal sent through said second channel with a high-frequency filter to produce a second filtered signal, then amplifying the second filtered signal sent through said second channel with a third amplifier to produce a final second channel signal, and then sending the final second channel signal to the right ear of said listener. A computer may be used to display a graphical representation of a face in accord with voice emotive cues as they occur in the speech signal by adjusting the gestures and features of said face and/or the kinemics of a graphical representation of a body.

### BRIEF DESCRIPTION OF THE DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a diagrammatic flow-chart of one embodiment of the present invention in which components are interconnected to provide a means for affecting the method of the present invention.

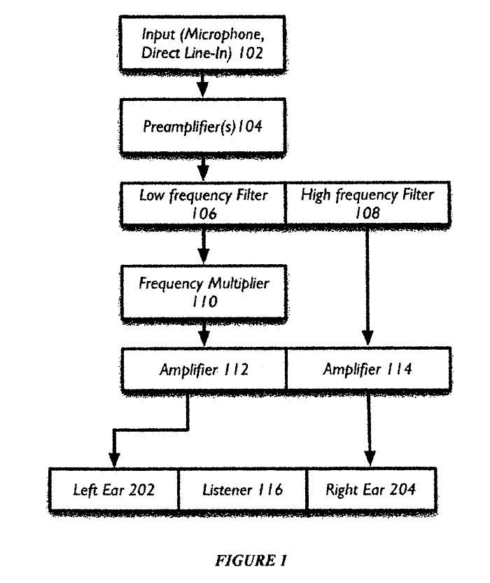

### DEFINITIONS

Certain terms of art are used in the specification that are to be accorded their generally accepted meaning within the relevant art; however, in instances where a specific definition is provided, the specific definition shall control. Any ambiguity is to be resolved in a manner that is consistent and least restrictive with the scope of the invention. No unnecessary limitations are to be construed into the terms beyond those that are explicitly defined. Defined terms that do not appear elsewhere provide background. The following term(s) are hereby defined:

FILTER: An electrical device used to affect certain parts of the spectrum of a sound, generally by causing the attenuation of bands of certain frequencies. In the present invention, a filter may comprise, without limit: high-pass filters (which attenuate low frequencies below the cut-off frequency); low-pass filters (which attenuate high frequencies above the cut-off frequency); band-pass filters (which combine both high-pass and low-pass functions); band-reject filters (which perform the opposite function of the band-pass type); octave, half-octave, third-octave, tenth-octave filters (which pass a controllable amount of the spectrum in each band); shelving filters (which boost or attenuate all frequencies above or below the shelf point); resonant or formant filters (with variable centre frequency and Q). A group of such filters may be interconnected to form a filter bank. In embodiments of the present invention, where more than one filter may be used to properly adjust the characteristics of a signal, a filter may be a single filter, a group of filters, and/or a filter bank.

### DETAILED DESCRIPTION OF THE INVENTION

Emotional, non-verbal cues and verbal cues provide information that is processed as meaning within the brain. The brain processes for such cues are separate but function similarly among individuals even between culturally disparate individuals. The present invention, in one or more embodiments, provides a method adapted to train an individual in recognizing non-verbal cues via computer assistance. Such non-verbal cues include both acoustical cues such as the pitch, inflection, and tone of a word or words, and also related kinesics such as body behavior and facial expression. With respect to facial expression, the method will be particularly adapted for improving the understanding by a non-fluent speaker of speech which is presented by an individual in close proximity to the listener, i.e. the listener is within range to view the speaker's facial expression. Such facial cues are often not perceptible by non-fluent speakers because their attention is typically focused on the meaning of verbal communication. The present invention also provides, in one or more embodiments, a strategy or method for computer training of non-fluent speakers to recognize such non-verbal cues. In addition, the present invention may also comprise a device which can be used in actual person-to-person, i.e. real-life, encounters by providing a means adapted to process non-verbal cues.

The method functions by extracting the emotional voice or prosodic cues by filtering, frequency multiplication and amplification, to enhance perception of these cues. During training, a facial display adapted to present emotional gestures can be used to enhance non-verbal communication sensitivity. Any user with normal native language abilities can use such a system. In addition, the application is functional to increase semantic understanding in cross-cultural linguistic interactions, in treating pragmatic language disorders such as semantic defects, in treating persons with autism or stroke-based language impairment, or even in military and law enforcement applications.

The present invention comprises at least two preferred embodiments. The first preferred embodiment comprises a multimodal training system further comprising visual reinforcement. Multimodal means that the signal output may be presented visually, acoustically, tactically, or by any other sensory mode. The second preferred embodiment comprises the non-verbal cue extraction capabilities of the first embodiment and presents them in a stand-alone (optionally wearable) device for use in day-to-day interactions. In describing the device, it is to be noted that other devices that affect the method of the present invention are usable, i.e. the following devices are exemplary means for affecting the method of the present invention. The above embodiments and others may comprise the following elements:
1. At least one input device 102 such as a microphone or direct line (including wireless “lines”, e.g., RF signals received by the input device) receiving live or recorded data comprising acoustic signals;
2. At least one preamplifier 104 for the acoustic signal delivered by the input device 102;
3. At least one filter having at least one channel, in which the signal from preamplifier 104 is channeled such that a filter or filters 106 act to remove low frequencies (less than 500 Hertz) and a filter or filters 108 act to remove high frequencies 104 (greater than 500 Hertz). The low frequency channel filter will produce a signal for presentation to the right ear 204, while the low frequency channel filter will produce a signal for presentation to the left ear 202, both after any remaining processing;
4. At least one frequency multiplier 110 adapted to double the frequencies of any signal from filter or filters 106. Other multiplication factors, e.g. ×1.5, ×2.5, ×3, ×0.75, may be used;
5. At least one amplifier 112 or more 114 adapted to increase the volume of the incoming signals. Speech sounds may be increased in volume in reference to the high-frequency speech sent to the right ear. Alternatively, attenuators may be used to accomplish the same result;
6. A person 116 having a left ear 202 and a right ear 204 receives the processed signals from the amplifiers 112 and/or 114;
7. During listening, a user 106 may during multimodal training view a computer-generated face 300 which changes over time 302 in response to the speech signal 306 changing over time 304, thereby allowing facial cue awareness in addition to stressed emotional processing of the prosody of speech; and
8. A battery-operated device, e.g., one mounted on a pair of glasses, may used to enhance speech a listener is exposed to in day-to-day interactions. Such received sound could be processed and provided to the ears of a listener.

The individual elements described above may, in one or more embodiments of the present invention, interact and interconnect as follows:
9. Speech, live or recorded, from an input device 102 is split into two channels.

These channels may be pre-amplified and filtered as by components 104 and 106/108 respectively. One channel will pass low frequencies and the other channel will pass high frequencies. While 500 Hertz is described as one preferred frequency split point, other frequencies are also contemplated, particularly those which improve the understanding of non-verbal cues by a listener.
10. The low frequency channel may be frequency multiplied, for example, it is preferred in one embodiment that the low-frequency signal is doubled. Expansion of the signal is generally preferred because users are better able to perceive intonations and prosody cues when the signal is frequency expanded.
11. The processed speech channels may be fed into amplifiers or attenuators before being sent to earphones.
12. The high frequency speech is fed into the right ear and the low-frequency multiplied speech is fed into the left ear. The levels are adjusted such that the low frequency information is available to the listener.
13. Finally, a user may also be presented with a computer image of a speaker producing the speech as it is relayed to the user. The facial cues corresponding to the low-frequency cues become apparent in this arrangement.

As can be seen by the exemplary interconnection of elements, the present method relies on a series of amplification, filtration, and frequency multiplication steps resulting in separate signals being sent to different ears of a listener. A key feature of the method is that the low-frequency signals are frequency multiplied, thereby increasing the saliency of emotive cues. In sum, the method comprises the steps of using an input device to receive a signal comprising speech; using a first amplifier to amplify said signal; sending said signal through a first and a second channel; filtering the signal sent through said first channel with a low-frequency filter, then frequency multiplying signal sent through said first channel, then amplifying the signal sent through said first channel with a second amplifier, and then sending the signal sent through said first channel to the left ear of said listener; and filtering the signal sent through said second channel with a high-frequency filter, then amplifying the signal sent through said second channel with a third amplifier, and then sending the signal sent through said second channel to the right ear of said listener. The method may be further adapted by using a computer to generate a face that displays emotive cues present in the signal to a listener for viewing while listening. The manner of operation of the present invention is now further described.

Voice cues or prosody cues are processed in the right brain and are generally not recognized by the listener at a conscious level unless the listener is fluent and/or comfortable in the language. The present invention comprises an innovative means for making voicing cues more salient and recognizable by modulating the frequency and intensity of these signals. Voice salience may be improved by digital processing involving computer-assisted instruction. Adaptation of the method may include devices for use in portable and/or wearable units and is a contemplated useful feature of one or more embodiments of the present invention.

In the multimodal embodiment, facial expressions comprising emotive gestures and even body images comprising kinemics, e.g. bodily behaviors/gestures, may be provided. The displayed image is adapted to show various emotive cues used in various communications. For example, training software may be used to represent a series of video clips of staged interactions with a variety of people in a particular culture. The interactions may comprise “honest” encounters or encounters in which non-verbal or kinesic cues indicate deception. The image can comprise a fully articulated graphic body capable of speech intonation, pitch changes, and related voce emotion cues plus facial expressions that change with speech.

The device operates in a manner that utilizes the neurologically distinct and culturally invariant capabilities of the brain to process voice emotional cues, kinemics related to voice or prosody cues, and facial expressions.

Because non-verbal communication (NVC) cues are typically universally translatable to foreign languages because of the cultural invariance of many of these cues, they are typically available to fluent speakers but not non-fluent speakers. The capability of a fluent speaker to integrate NVC cues with tone, inflection, and/or prosidy cues, along with the actual speech of a speaker is a primary capability. This ability becomes secondary amongst non-fluent speakers. By reinforcing the saliency and presence of these voice cues, alone or with the added non-verbal bodily (kinesic) cues, a non-fluent speaker is better able to assess the proper meaning of a phrase. Such a process trains the user to recognize these cues in later encounters thereby producing improved fluency in a language.

In the foregoing description, certain terms and visual depictions are used to illustrate the preferred embodiment. However, no unnecessary limitations are to be construed by the terms used or illustrations depicted, beyond what is shown in the prior art, since the terms and illustrations are exemplary only, and are not meant to limit the scope of the present invention. It is further known that other modifications may be made to the present invention, without departing the scope of the invention, as noted in the appended claims.

I claim:

1) A method for presenting verbal cues to a listener comprising:
i. receiving a raw signal comprising speech using an input device;
ii. amplifying said raw signal using a first amplifier to produce an amplified signal;
iii. sending said amplified signal through a first and a second channel;
iv. filtering the amplified signal sent through said first channel with a low-frequency filter to produce a first filtered signal,
then frequency multiplying the first filtered signal sent through said first channel to produce a frequency multiplied signal,
then amplifying the frequency multiplied signal sent through said first channel with a second amplifier to produce a final first channel signal,
and then sending the final first channel signal to the left ear of said listener; and
v. filtering the amplified signal sent through said second channel with a high-frequency filter to produce a second filtered signal,
then amplifying the second filtered signal sent through said second channel with a third amplifier to produce a final second channel signal,
and then sending the final second channel signal to the right ear of said listener.

2) The method of claim 1, in which the first and second channel signals are presented to the listener in conjunction with a graphical representation of a face on a computer, in which said computer adjusts the gestures and features of the face to accord with voice emotive cues of the signal.

3) The method of claim 2, in which said computer is further adapted to display kinemics.

4) The method of claim 1 in which the low-frequency filter and high-frequency are bounded at about 500 Hertz.

5) The method of claim 1 in which said speech signal is frequency multiplied by a factor of about two.

6) A method for extracting emotive and/or prosodic verbal cues from speech for presentation to a listener comprising receiving a signal comprising speech, filtering said signal by removing frequencies above or below a set-point, frequency multiplying said signal, amplifying or attenuating said signal, and sending the signal below said frequency set-point to an ear and sending the signal above said frequency set-point to another ear.

7) A method of treating hearing dysfunction by using the method of claim 1 or claim 6 to train a user in understanding intonations and prosody cues.

8) A method of training a user to better perceive voice cues by using the method of claim 6.
